(19) United States
(12) Patent Application Publication
(10) Pub. No.: US 2026/0167071 A1
(43) Pub. Date: Jun. 18, 2026

(54) DAMPENING SYSTEM FOR SEAT ASSEMBLY

(71) Applicant: Textron Inc., Providence, RI (US)

(72) Inventor: Jonathan Luis Valdes, Graniteville, SC (US)

(73) Assignee: Textron Inc., Providence, RI (US)

(21) Appl. No.: 18/980,866

(22) Filed: Dec. 13, 2024

(51) Int. Cl. B60N 2/50; B60N 2/52

(52) U.S. Cl. CPC B60N 2/502; B60N 2/522

(57) ABSTRACT

A seat assembly may include a padding layer configured to support at least two passengers of the golf vehicle. The seat assembly may also include a first base layer coupled to the padding layer and spaced from a second base layer spaced such that a gap is present between the first base layer and the second base layer. The seat assembly may include a dampening system positioned in the gap between the first base layer and the second base layer. The dampening system may include at least one of a plurality of springs, a space frame, or a pneumatic system.

### BACKGROUND

Recreational vehicles (e.g., golf vehicles, personal transport vehicles, utility task vehicles, etc.) are used to transport personnel and equipment. Seat assemblies of recreational vehicles may result in vibrations being felt by passengers of the vehicles during operation of the vehicle.

### SUMMARY

One embodiment relates to a seat assembly for a golf vehicle. The seat assembly includes a padding layer configured to support at least two passengers of the golf vehicle, a first base layer coupled to the padding layer, a second base layer spaced from the first base layer such that a gap is present between the first base layer and the second base layer, and a dampening system positioned in the gap between the first base layer and the second base layer.

Another embodiment relates to a golf vehicle. The golf vehicle includes a chassis and a seat assembly. The seat assembly includes a seat frame coupled to the chassis and a seat bottom supported by the seat frame. The seat bottom is configured to support at least two passengers. The seat bottom includes a padding layer, a first base layer coupled to the padding layer, a second base layer spaced from the first base layer such that a gap is present between the first base layer and the second base layer, and a dampening system positioned in the gap between the first base layer and the second base layer.

Still another embodiment relates to a recreational vehicle. The recreational vehicle includes a chassis and a seat assembly. The seat assembly includes a seat frame coupled to the chassis and a seat bottom supported by the seat frame. The seat bottom includes a padding layer, a first base layer coupled to the padding layer, a second base layer spaced from the first base layer such that a gap is present between the first base layer and the second base layer, and a dampening system including a plurality of springs positioned in the gap between the first base layer and the second base layer. The first base layer and the second base layer are manufactured from plywood.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a perspective view of a seat assembly with a dampening system, according to an exemplary embodiment.

FIG. 4 is a cross-sectional view of the seat assembly of FIG. 3, according to an exemplary embodiment.

FIG. 5 is a cross-sectional view of the seat assembly of FIG. 3, according to another exemplary embodiment.

FIG. 6 is a cross-sectional view of the seat assembly of FIG. 3, according to another exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

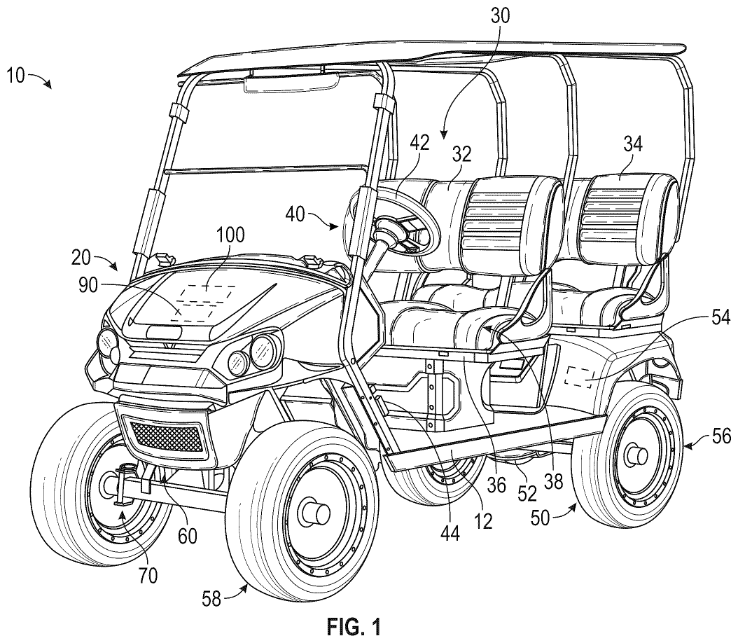

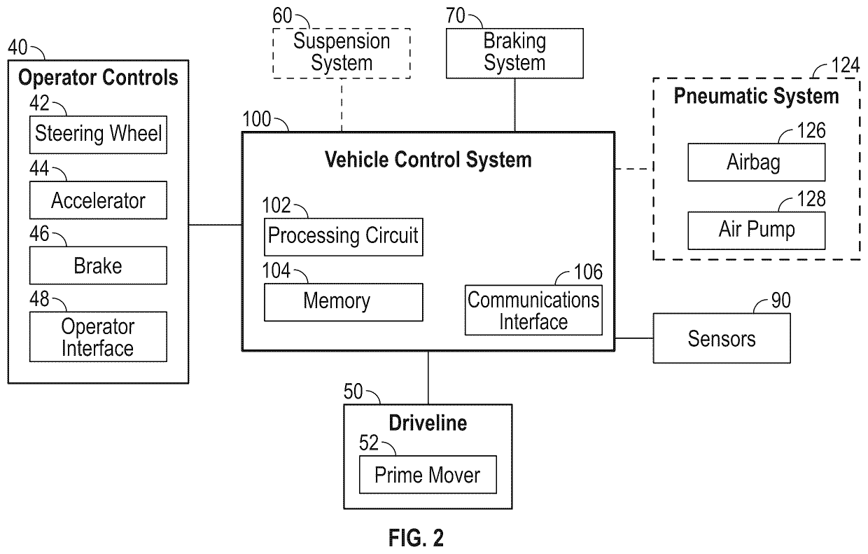

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart or vehicle, an all-terrain vehicle (“ATV”), a utility task vehicle (“UTV”), a low speed vehicle (“LSV”), a personal transport vehicle (“PTV”), a hauler, a ground support equipment (“GSE”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

As shown in FIG. 1, the front row of seating 32includes a seat assembly, shown as seat frame 36, and a seat cushion, shown as seat bottom cushion 38, supported by the seat frame 36. The seat frame 36 may be coupled to the frame 12. In embodiments where the occupant seating area 30 includes the rear row seating 34, the rear row seating 34 may similarly include the seat frame 36 and the seat bottom cushion 38. In some embodiments, the seat bottom cushion 38 is removably coupled to the seat frame 36, such that the seat bottom cushion 38 can be interchanged. According to the exemplary embodiment shown in FIG. 1, the seat bottom cushion 38 is configured as a bench seat cushion that supports a plurality of passengers (e.g., two, three, etc.) of the vehicle 10. In other embodiments, the seat bottom cushion is configured to support a single passenger of the vehicle 10 (e.g., a captain chair cushion). In various embodiments as discussed herein, the seat bottom cushion 38 includes one or more mechanisms (e.g., a dampening system) configured to facilitate providing enhanced comfort and support to passengers of the vehicle 10 relative to traditional seats of a recreational vehicle.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., the motor 53) and the energy storage 54 is a battery system (e.g., the battery module 57, the add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Seat Assembly

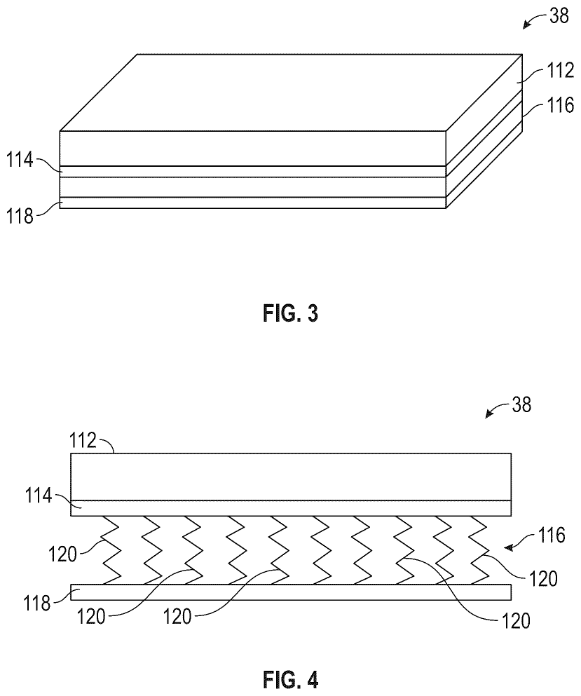

As shown in FIGS. 3-6, the seat bottom cushion 38 includes a first layer, shown as padding layer 112, a second layer, shown as first base layer 114, a third layer, shown as second base layer 118, and a fourth or shock attenuating layer including a dampening assembly, shown as dampening system 116. The first base layer 114 is coupled to the padding layer 112 and spaced from the second base layer 118 such that a gap is present between the first base layer 114 and the second base layer 118. The dampening system 116 is positioned in the gap between the first base layer 114 and the second base layer 118. According to an exemplary embodiment, the configuration of the seat bottom cushion 38 with the dampening system 116 aids in reducing vibrations and shocks/impacts felt by passengers of the vehicle 10 when the vehicle 10 is in operation.

The padding layer 112 may be manufactured from a number of materials (e.g., foam, feathers, cotton, memory foam, etc.). The material used for the padding layer 112 aids in providing support and comfort for the passengers of the vehicle 10 while the vehicle 10 is in operation or stationery. For example, memory foam reduces vibrations and shocks/impacts felt by the passengers during operation of the vehicle 10.

In some embodiments, the second base layer 118 is coupled to the seat frame 36. By way of example, the second base layer 118 may be detachably and/or pivotably coupled to the seat frame 36. According to an exemplary embodiment, the first base layer 114 and the second base layer 118 are configured to provide support for the seat bottom cushion 38. In particular, the first base layer 114 and the second base layer 118 aid in providing structural support to the dampening system 116 and/or the padding layer 112. In some embodiments, the first base layer 114 and the second base layer 118 are configured to be a mounting point for the dampening system 116 such that a portion of the dampening system 116 is attached to the first base layer 114 and the second base layer 118. The first base layer 114 and the second base layer 118 may also ensure that the dampening system 116 is properly aligned such that vibrations and shocks/impacts during operation of the vehicle 10 are properly distributed and dampened by the dampening system 116.

In some embodiments, the first base layer 114 and the second base layer 118 are manufactured from the same material. In some embodiments, the material used is plywood. Other materials such as steel or aluminum may also be used to manufacture the first base layer 114 and the second base layer 118. In other embodiments, the first base layer 114 is manufactured from a first material and the second base layer 118 is manufactured from a second material different from the first material.

According to an exemplary embodiment, the dampening system 116 is configured to improve the overall comfort and support of the passengers of the vehicle 10. The dampening system 116 may have mechanisms and systems configured to reduce an impact of vibrations and shocks/impacts transmitted from the vehicle 10 and/or an environment in which the vehicle 10 is in. The reduction in vibrations shocks/impacts reduces sudden movements that may be felt by the passengers, resulting in an improvement in comfort. Additionally, the dampening system 116 may be configured to improve longevity of the seat bottom cushion 38. Particularly, the dampening system 116 is configured to absorb energy/forces, which may have otherwise led to the destruction of the seat bottom cushion 38 (e.g., by damaging the material of the padding layer 112). As described in greater detail herein, the dampening system 116 may be or include at least one of a plurality of springs, a space frame, or a pneumatic system.

### Dampening System

As shown in FIG. 4, the dampening system 116 includes a plurality of biasing members, shown as springs 120. The springs 120 are coupled to and extend between the first base layer 114 and the second base layer 118. In some embodiments, the first base layer 114 and the second base layer 118 include an apparatus for the springs 120 to coupled to. The springs 120 are configured to absorb energy and reduce vibrations and shocks/impacts in order to improve an experience for the passengers of the vehicle 10. For example, during operation of the vehicle 10, the springs 120 may compress in order to absorb at least some of the energy from vibrations of and/or shocks/impacts to the vehicle 10, which reduces vibrations that are felt by the passengers of the vehicle 10. In some embodiments, the dampening system 116 includes a damper and/or a shock absorber (e.g., a shock, an airbag, a pneumatic bladder, etc.) in order to aid in dampening the vibrations. In such embodiments, the springs 120 may be positioned circumferentially around the damper and/or the shock absorber. In some embodiments, each of the springs 120 and each damper are integrated into a single assembly (e.g., a strut).

The springs 120 may be manufactured from a number of materials (e.g., steel, titanium, copper, rubber) depending on cost restrictions, overall purpose and uses, etc. The springs 120 may be arranged in a number of ways depending on specific needs. For example, as is shown in FIG. 4, the springs 120 may be arranged side by side with an end of each of the springs 120 coupled to either the first base layer 114 or the second base layer 118. In another example, the springs 120 may be arranged in a staggered pattern where a second row of springs 120 is positioned in a space between its adjacent rows of springs, and so on. Additionally, different combination of springs 120 (e.g., steel, titanium) may be used.

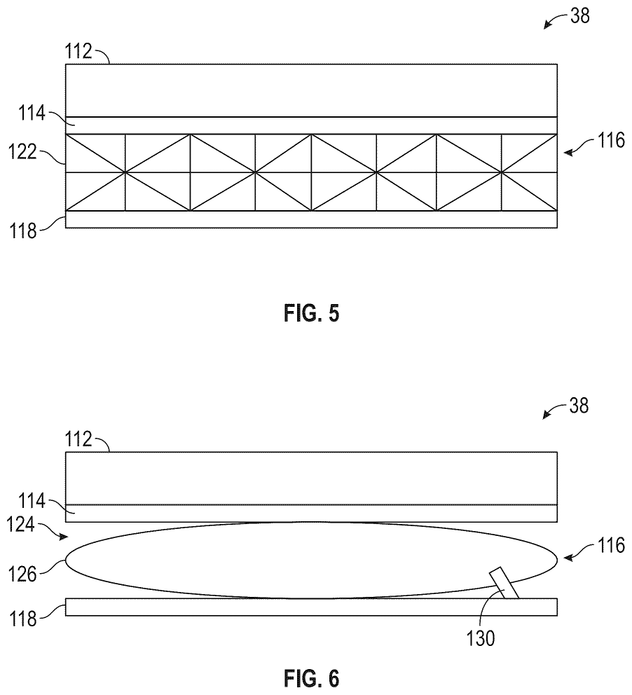

As shown in FIG. 5, the dampening system 116 includes a frame assembly, lattice structure, etc., shown as space frame 122. The space frame 122 is configured to provide structure and support to the seat bottom cushion 38 while reducing vibrations and/or shocks during operation of the vehicle 10. The space frame 122 has a lattice of supports (e.g., rods, beams, arms, connectors, etc.) arranged in a pattern to ensure vibrations and/or shocks/impacts are evenly distributed and reduced. The pattern of the space frame 122 may be triangular, as is shown in FIG. 5, tetrahedral, hexagonal, etc.

The space frame 122 may be manufactured from a number of materials. In some embodiments, the space frame 122 is manufactured from an elastomeric material (e.g., rubber, silicone, polyurethane, etc.). The use of the elastomeric material for the space frame 122 allows for the space frame 122 to deform and reduce vibrations and shocks/impacts without compromising the structure. The space frame 122 may also be manufactured from other suitable materials that provide flexibility and shock/impact absorption capabilities.

As shown in FIGS. 2 and 6, the vehicle 10 and the dampening system 116 of the seat bottom cushion 38 include a pneumatic assembly, shown as pneumatic system 124. The pneumatic system 124 includes a pneumatic bladder, shown as airbag 126, and a driver, shown as air pump 128, and a conduit, shown as air conduit 130. According to an exemplary embodiment, the air conduit 130 fluidly couples the air pump 128 to the airbag 126.The pneumatic system 124 is configured to absorb energy from vibrations of the vehicle 10 and/or shocks/impacts to the vehicle 10 by using compressed air or other gases stored in the airbag 126. The airbag 126 may be or function like a gas spring or an air spring. The airbag 126 stores the compressed air and when a vibration and/or shock occurs, the air absorbs at least a portion of the vibration and/or shock. In some embodiments, the pressure within the airbag 126 is controllable by the occupant of the vehicle 10 to adjust the amount vibration/shock attenuation. In some embodiments, the pneumatic system 124 is actively controlled to release air from or supply air to the airbag 126 through the air conduit 130 to actively control the pressure within the airbag 126 such that the pneumatic system 124 actively adjusts to absorb energy from the vibrations/shocks. The air pump 128 releases air from or supplies air to the airbag 126 in order to maintain/adjust pressure levels within the airbag 126 and adjust the pneumatic system 124. The airbag 126 may be manufactured from a number of materials (e.g., rubber, plastic, synthetic fabrics, elastomeric materials, etc.). The material for the airbag 126 allows for flexibility and durability as the airbag 126 expands and/or contracts. In various embodiments, as is shown in FIG. 6, the airbag 126 may be bladder-style. The airbag 126 may also be cylindrical, conical, rectangular, etc.). In some embodiments, the airbag 126 is replaced with a controllable pneumatic shock.

The pneumatic system 124 may also include a number of other components in order to improve functionality and performance of dampening. For example, the pneumatic system 124 may include a reservoir for storing compressed air, such that a consistent supply of air is available for the airbag 126. Additionally, the pneumatic system 124 may include a compressor for generating compressed air or additional valves or orifices for control amount of air entering and leaving the pneumatic system 124.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the fleet monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A seat assembly for a golf vehicle, the seat assembly comprising:
a padding layer configured to support at least two passengers of the golf vehicle;
a first base layer coupled to the padding layer;
a second base layer spaced from the first base layer such that a gap is present between the first base layer and the second base layer; and
a dampening system positioned in the gap between the first base layer and the second base layer.

2. The seat assembly of claim 1, wherein the dampening system includes at least one of (a) a plurality of springs, (b) a space frame, or (c) a pneumatic system.

3. The seat assembly of claim 2, wherein the dampening system includes the plurality of springs.

4. The seat assembly of claim 2, wherein the dampening system includes the plurality of springs.

5. The seat assembly of claim 4, wherein the space frame is manufactured from an elastomeric material.

6. The seat assembly of claim 2, wherein the dampening system includes the pneumatic system.

7. The seat assembly of claim 6, wherein the pneumatic system includes an airbag.

8. The seat assembly of claim 1, wherein the first base layer and the second base layer are manufactured from the same material.

9. The seat assembly of claim 8, wherein the first base layer and the second base layer are manufactured from plywood.

10. A golf vehicle comprising:
a chassis; and
a seat assembly including:
a seat frame coupled to the chassis; and
a seat bottom supported by the seat frame, the seat bottom configured to support at least two passengers, the seat bottom including:
a padding layer;
a first base layer coupled to the padding layer;
a second base layer spaced from the first base layer such that a gap is present between the first base layer and the second base layer; and
a dampening system positioned in the gap between the first base layer and the second base layer.

11. The golf vehicle of claim 10, wherein the dampening system includes at least one of (a) a plurality of springs, (b) a space frame, or (c) a pneumatic system.

12. The golf vehicle of claim 11, wherein the dampening system includes the plurality of springs.

13. The golf vehicle of claim 11, wherein the dampening system includes the space frame, the space frame manufactured from an elastomeric material.

14. The golf vehicle of claim 11, wherein the dampening system includes the pneumatic system, the pneumatic system including an airbag.

15. The golf vehicle of claim 10, wherein the first base layer and the second base layer are manufactured from the same material.

16. The golf vehicle of claim 14, wherein the first base layer and the second base layer are manufactured from plywood.

17. A recreational vehicle comprising:
a chassis; and
a seat assembly including:
a seat frame coupled to the chassis; and
a seat bottom supported by the seat frame the seat bottom including:
a padding layer;
a first base layer coupled to the padding layer,
a second base layer spaced from the first base layer such that a gap is present between the first base layer and the second base layer, the first base layer and the second base layer manufactured from plywood, and
a dampening system including a plurality of springs positioned in the gap between the first base layer and the second base layer.

18. The recreational vehicle of claim 17, wherein the dampening system includes a least one of (a) a space frame or (b) a pneumatic system.

19. The recreational vehicle of claim 17, wherein the seat bottom is configured to support at least two passengers.

20. The recreational vehicle of claim 17, wherein the recreational vehicle is a golf vehicle, a personal transport vehicle, a low speed vehicle, a utility task vehicle, or a hauler vehicle.
